(19) United States
(12) Patent Application Publication
(10) Pub. No.: US 2007/0114170 A1
(43) Pub. Date: May 24, 2007

(54) Fuel filter cartridge apparatus

(75) Inventors: Timothy L. Krull, Kearney, NE (US); Russell D. Ridgway, Kearney, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 11/283,013

(22) Filed: Nov. 18, 2005

(51) Int. Cl. B01D 35/28

(52) U.S. Cl. 210/445; 210/455

(57) ABSTRACT

In a fluid filter cartridge, and a method for manufacturing a fluid filter cartridge, a drain fitting is attached by a crimped joint to a housing of the filter cartridge. The drain fitting is loosely fitted into the housing, prior to forming the crimped joint. The drain fitting has an outer periphery thereof which includes a crimping recess therein and the housing includes a crimped portion thereof which is formed into the crimping recess of the drain fitting to form the crimped connection. The crimping recess further includes anti-rotation features in the form of raised ribs about which the crimped portion of the housing is formed for resisting rotation of the drain fitting with respect to the housing.

### FIELD OF THE INVENTION

This invention relates generally to devices for filtering and separating fluids. More particularly, the invention relates to fuel filters for removing foreign particles and separating water from fuel and fuel supply systems of a engine.

### BACKGROUND OF THE INVENTION

In order to ensure proper operation, and long life of an engine, it is known in the art to provide a fuel filter having an element that is capable of removing particulate matter and water from the fuel being supplied to the engine. Generally, such fuel filters include a disposable filter cartridge which is detachably mounted to a base, so that the filter cartridge can be replaced at periodic intervals. The base and fuel cartridge are cooperatively configured in such a manner that the base directs fluid into and out of the cartridge.

Filter cartridges, of the type used for filtering fuel being supplied to an engine, typically include a filter pack, also sometimes referred to as a filter element, mounted within a filter housing disposed about the filter pack, with a lower end of the housing defining a fluid sump extending substantially below the filter pack at the lower end of the housing. The mounting base and cartridge are configured in such a manner that fuel entering the filter is directed around the outside of the filter element, and such that the filtered and de-watered fuel is removed from the interior of the filter element. The filter element is constructed in such a manner that water coalesces on the outside of the filter element, and is directed into the sump of the housing by the force of gravity.

In order to allow periodic draining of the separated water from the sump, the filter housing also typically includes a drain fitting passing through the housing in the sump region, and attached to the housing. Such drain fittings are typically configured for threaded attachment thereto of a drain cock which allows the drain fitting to be selectively sealed or opened for draining water out of the housing of the filter cartridge.

In some filters, the drain fitting is further adapted for attachment thereto of a drain bowl providing an additional sump area for receiving water. Such drain bowls are sometimes fabricated of transparent or translucent materials allowing a visible indication from outside the filter of how much water is present within the drain bowl. The drain bowl also typically includes a drain bowl drain cock which allows selective draining of the water in the drain bowl, at periodic intervals. U.S. Pat. No. 5,236,579 to Janik et al. discloses a fuel filter assembly with modular drain bowl, of the type generally described above.

Because the filter cartridge is a throw-away item, it is highly desirable that the cartridge be configured in a manner conducive to automated assembly at a low cost. The manner in which a drain fitting is attached to the housing in such filters can significantly impact the manufacturability and overall costs of the filter cartridge.

In some prior filter cartridges, including the cartridge disclosed in the Janik '579 patent, the drain fitting is press-fitted into a protrusion extending from a lower end of the cartridge housing. In order to ensure that an adequate connection is formed between the drain fitting and the housing, where the drain fitting is press-fitted into the housing, it is necessary that an outer peripheral portion of the drain fitting, and a mating inside surface of the housing, be accurately controlled to close tolerances. The necessity for maintaining such close tolerances on the drain fitting and housing tends to drive up manufacturing cost and difficulty.

Experience has also shown, that where a drain fitting is simply pressed into a housing, the drain fitting may loosen over time, and rotate with the drain cock, or other bolted attachments to the drain fitting, in such a manner that it is not possible to drain the contents from the sump of the filter. It is also noted that, should the drain fitting become loose, in prior filter cartridges having the drain fitting merely pressed into the housing, the drain fitting may be pulled out of, or pushed into the interior of, the housing during operation of a drain cock or other threaded fastener attaching a fluid bowl to the filter cartridge.

It is desirable, therefore, to provide an improved filter cartridge, and a method for manufacturing a filter cartridge, which overcome one or more of the problems described above. It is further desirable that such an improved filter cartridge be adaptable for use with existing filter bases, and allowing use of the filter cartridge with either a typical drain cock, and/or a fluid bowl.

### BRIEF SUMMARY OF THE INVENTION

The invention provides an improved fluid filter cartridge, and method for manufacturing such an improved fluid filter cartridge, by utilizing a crimped connection for attaching a drain fitting to a housing of the filter cartridge. Practice of the invention allows the drain fitting to be loosely fitted into the housing, prior to forming the crimped connection, thereby eliminating the additional complexity and cost associated with the press-fitted attachment of drain fitting to housings in prior filter cartridges, and providing a more secure joint to be formed between the drain fitting and housing than could be achieved in prior filter cartridges.

In one form of the invention, a filter cartridge includes a filter pack, and a housing disposed about the filter pack. The housing defines an upper and a lower end thereof, and a sump extending substantially below the filter pack at the lower end of the housing. The housing further includes a drain fitting passing through the housing in the sump and attached to the housing. The drain fitting has an outer periphery thereof which includes a crimping recess therein, and the housing includes a crimped portion thereof which is formed into the crimping recess of the drain fitting, to thereby form a crimped connection between the drain fitting and the housing.

The crimping recess may also include at least one anti-rotation feature, around which the crimped portion of the housing is formed for resisting rotation of the drain fitting with respect to the housing. Where the drain fitting defines an axis of passage through the housing, the crimping recess in the drain fitting may be a radially outwardly opening groove. An anti-rotation element, in the form of a raised rib, may extend outwardly from and substantially axially across the crimping recess.

The housing of a filter cartridge according to the invention, may include a tubular wall section thereof, disposed about the periphery of the drain fitting and including the crimped portion of the housing. A housing, according to the invention, may also have a cup-shaped extension thereof including the tubular wall, and having an axially facing end wall thereof joined to the tubular wall, with the end wall having a hole therein providing fluid communication with openings in the drain fitting. The drain fitting may be configured for operative attachment thereto of a drain cock, and the end wall of the cup-shaped extension may define a sealing surface thereof, adapted for cooperatively forming a sealable juncture with the drain cock, to thereby allow for selectively opening or closing-off fluid communication through the drain fitting.

A filter cartridge apparatus, according to the invention, may include either or both of, a filter pack disposed within the filter housing, and a sealing element operatively attached to the drain fitting, such as a drain cock and/or a drain bowl.

A method, according to the invention, for constructing a fluid cartridge having a drain fitting attached to a housing with a crimped connection, may include configuring the housing to have a crimpable portion thereof for attachment to the drain fitting, and loosely inserting the drain fitting into the crimpable portion before forming the crimped connection. A method, according to the invention, may also include configuring an outer peripheral surface of the drain fitting to have a crimping groove, and forming the crimpable portion of the housing into the crimping groove of the drain fitting to thereby form the crimped connection between the housing and the drain fitting.

A method, according to the invention, may further include configuring the housing of a fluid filter cartridge according to the invention to include a tubular wall section thereof, disposed about the periphery of the drain fitting and including the crimpable portion of the housing. A method may further include configuring the housing to provide a cup-shaped extension thereof, with the cup-shaped extension including the tubular wall and having an axially facing end wall of the cup-shaped extension joined to the tubular wall, with the end wall having a hole therein for providing fluid communication with the drain fitting. A method, according to the invention, may yet further include configuring the end wall of the cup-shaped extension to define a sealing surface thereof, for cooperatively forming a sealable juncture with a sealing element, to thereby selectively open or close-off fluid communication through the drain fitting.

A sealing element, in accordance with the invention, may take a variety of forms, including a resilient seal member, a drain cock, and/or a drain bowl.

Other aspects, objectives and advantages of the invention will be apparent from the following detailed description taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a vertical cross-section taken through a filter apparatus including an exemplary embodiment of a fluid filter cartridge, in accordance with the invention;

FIG. 2 is a partially cut-away perspective illustration of the drain fitting of the exemplary embodiment of the filter cartridge shown in FIG. 1;

FIG. 3 is a partially cut-away perspective illustration showing a crimped connection between the housing and the drain fitting of the exemplary embodiment of the filter cartridge shown in FIG. 1.

FIG. 4 is an enlarged partial cross-section of a sump area of the filter cartridge of the exemplary embodiment of the filter cartridge shown in FIG. 1, illustrating attachment of a drain cock to the drain fitting of the exemplary embodiment;

FIG. 5 is an enlarged partial cross-section of a sump area of the filter cartridge of the exemplary embodiment shown in FIG. 1, illustrating the manner in which a drain bowl is attached to the drain fitting of the exemplary embodiment of the filter cartridge;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

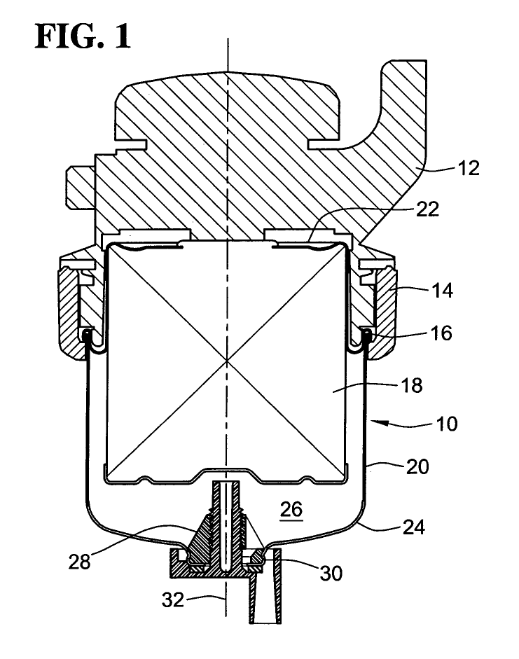

FIG. 1 shows an exemplary embodiment of the invention in the form of a filter cartridge apparatus 10, which is adapted for operative connection to a mounting base 12 by a retaining collar 14. In the exemplary embodiment, the filter cartridge 10 includes an integrally formed peripheral ridge 16, against which the retaining collar 14 bears, as the retaining collar 14 is screwed into place on the base 12, for forming an operative attachment between the filter cartridge 10 and the base 12. Those having skill in the art will recognize, however, that in other embodiments of a filter cartridge, according to the invention, the filter cartridge 10 may be attached to a mounting base in a variety of other ways.

The filter cartridge 10 includes a filter pack 18, and a housing 20 disposed about the filter pack 18. The housing 20 has an upper end 22 and a lower end 24 thereof, with the lower end 24 of the housing defining a sump 26 extending substantially below the filter pack 18 at the lower end 24 of the housing 20.

The housing 20 further includes a drain fitting 28 passing through the housing 20 in the sump 26, and attached to the housing 20 with a crimped connection 30, in a manner described in more detail below. The drain fitting 28 defines an axis of passage 32, through the housing 20. In the exemplary embodiment of the filter cartridge 10, the axis of passage 32 of the drain fitting 28 is substantially coincident with a central axis of the filter cartridge 10, but in other embodiments of the invention, the axis of passage need not necessarily be coincident with such a central axis of a filter cartridge according to the invention.

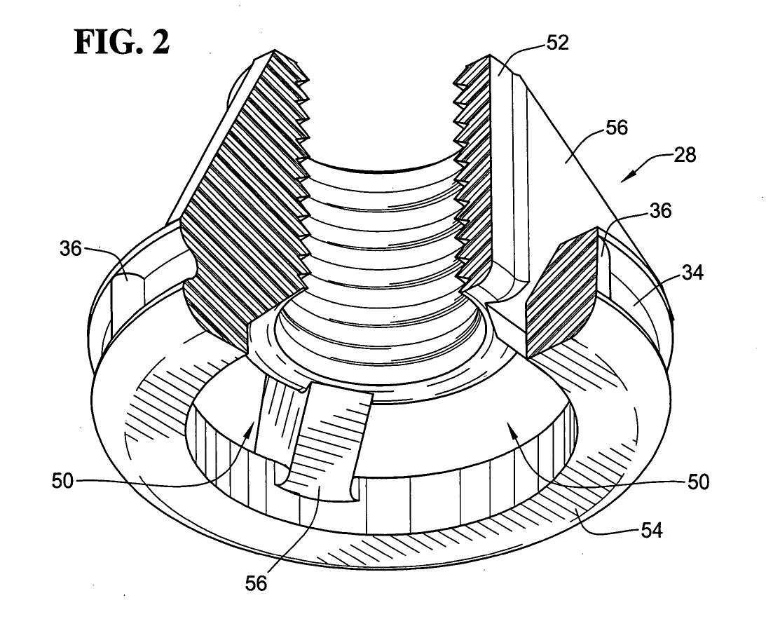

As shown in FIG. 2, the drain fitting 28, of the exemplary embodiment of the invention, has an outer periphery thereof including a crimping recess 34 therein, in the form of a radially outwardly opening groove. The crimping recess 34, of the exemplary embodiment, also includes a plurality of anti-rotation features, in the form of raised ribs 36 extending outwardly within and substantially axially across the crimping recess 34.

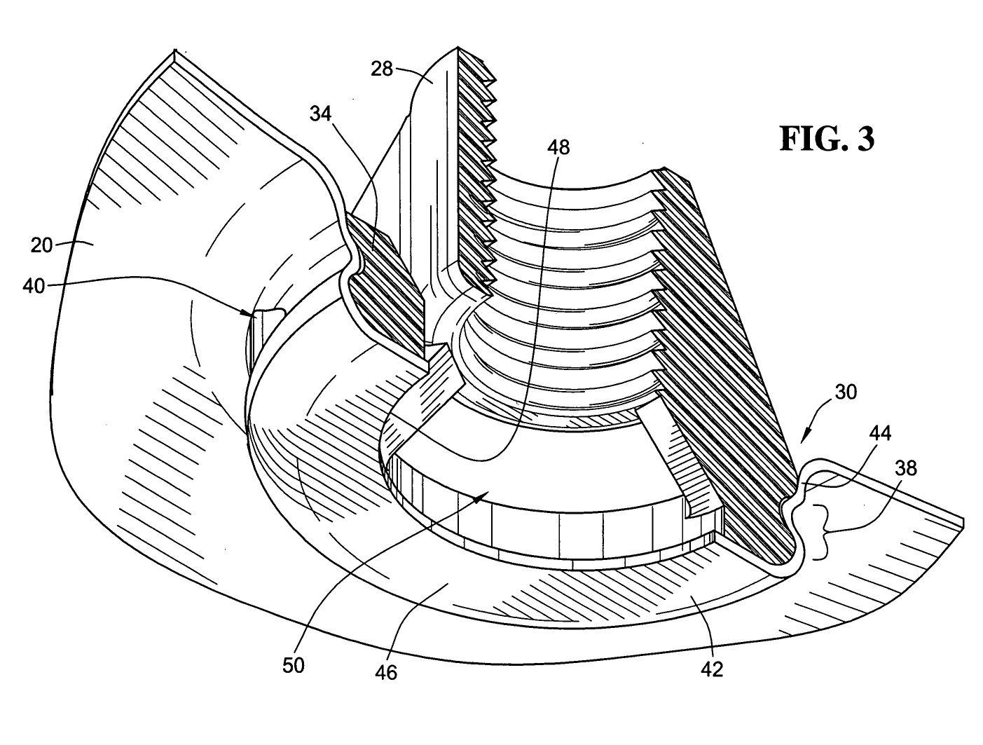

As shown in FIG. 3, the housing 20 includes a crimped portion 38 thereof, which is formed into the crimping recess 34, of the drain fitting 28, to thereby form the crimped connection 30 between the drain fitting 28 and the housing 20. As shown at 40, in FIG. 3, the crimped portion 38 of the housing 20 is also formed about the raised ribs 36 of the drain fitting 28 for restraining the drain fitting 28 against rotation with respect to the housing 20.

As further shown in FIG. 3, the housing 20, of the exemplary embodiment, includes a cup-shaped extension 42 including a tubular wall 44 and an axially facing end wall 46 thereof joined to the tubular wall 44 of the cup-shaped extension 42. The tubular wall section 44, of the cup-shaped extension 42, is disposed about the periphery of the drain fitting 28, and includes the crimped portion 38 of the housing 20. The end wall 46, of the cup-shaped extension 42, includes a hole 48 which is aligned with the drain fitting 28 and provides fluid communication with openings 50 extending through the drain fitting 28, for draining fluid from the interior of the filter cartridge 10. It will be appreciated that the cup-shaped extension 42 serves as a self-fixturing feature to properly position the drain fitting 28 axially and radially, with respect to the crimpable portion 38 of the housing 20, to thereby streamline construction and reduce cost.

As shown in FIG. 2, the drain fitting 28, of the exemplary embodiment includes a central female-threaded hub 52, joined to an outer rim 54 by a plurality of struts 56, with open spaces between the hub 52, outer rim 54, and struts 56 forming the openings 50 for passage of fluid through the drain fitting 28. It will be appreciated, however, that in alternate embodiments of the invention, a drain fitting may have a configuration differing substantially from the configuration of the drain fitting 28 of the exemplary embodiment described herein.

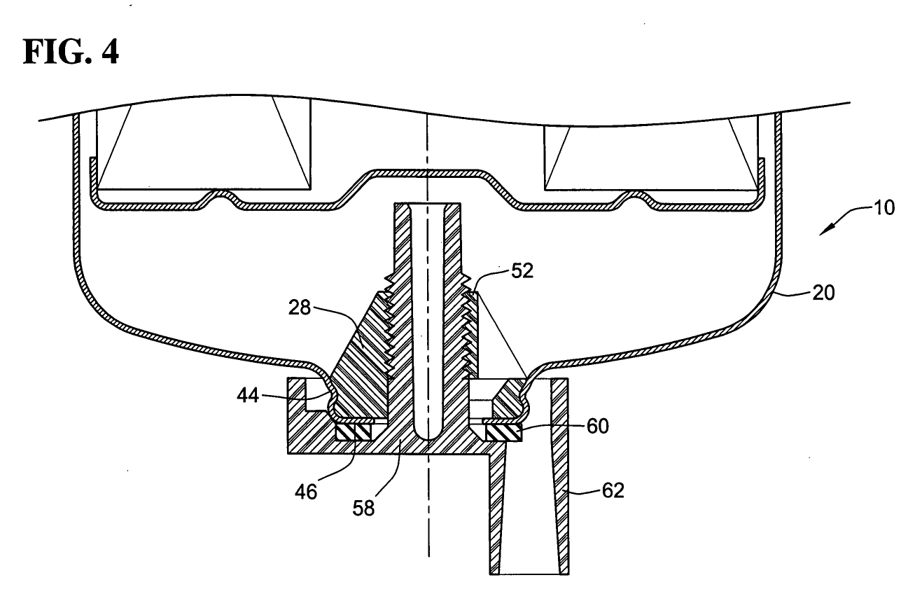

As shown in FIG. 4, by virtue of the configuration of the end wall 46 of the tubular wall portion 44 of the housing 20, of the exemplary embodiment of the filter cartridge 10, a resilient sealing member 60 of a sealing element, such as the drain cock 62 shown in FIG. 4, may cooperatively form a sealable juncture with the sealing element 62, to thereby allow for selectively opening or closing-off fluid communication through the drain fitting 28.

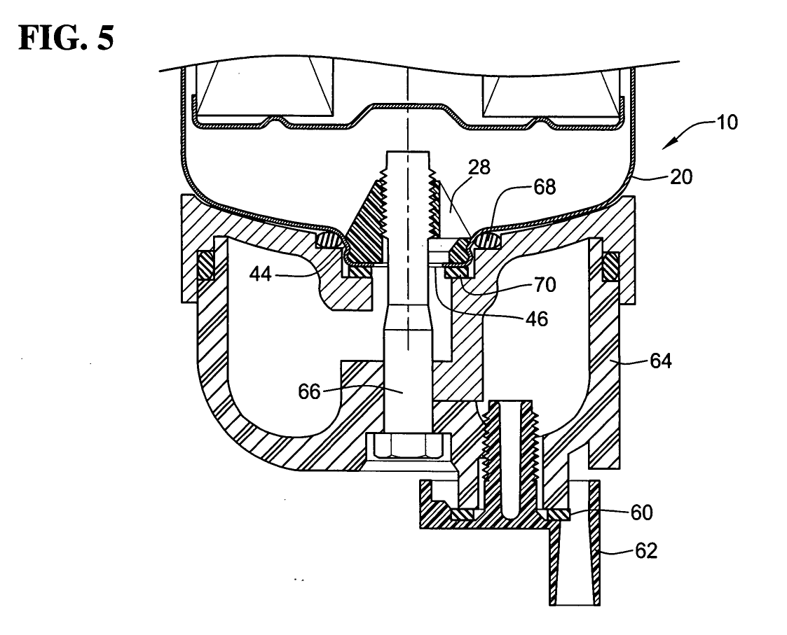

As shown in FIG. 5, the exemplary embodiment of the filter cartridge 10 is further configured in such a manner that a sealing element in the form of a drain bowl 64 may be operatively attached to the drain fitting 28 by a through-bolt 66. The drain bowl 64, shown in FIG. 5, includes a drain cock 62 and a resilient seal member 60 for draining fluid from the drain bowl 64. The configuration of the exemplary embodiment of the filter cartridge 10 allows for seals between the drain bowl 64 and housing 20 of the filter cartridge 10 to be placed around the cup-shaped extension 44, as indicated by O-ring seal 68, or alternatively by a face seal 70 bearing against the end wall 46 of the cup-shaped portion 42 of the housing 20.

It will be appreciated, by those having skill in the art, that, by virtue of the various features and elements of the exemplary embodiment described above, the crimped connection 30 allows far greater flexibility, and openness of manufacturing tolerances, than could be tolerated by prior filter cartridges in which a drain fitting was press-fitted into a housing. In a filter cartridge, according to the invention, the periphery of the drain fitting need not fit tightly into the housing in making the crimped joint. Furthermore, in embodiments of the invention utilizing anti-rotation features, and a substantially radially outwardly opening crimping groove, as described above in relation to the exemplary embodiment, a filter cartridge, according to the invention, provides far greater resistance to having the drain fitting pushed back into the interior of the housing, or rotating with respect to the housing, than can be achieved by prior filter cartridges in which a drain fitting is merely press-fitted into the housing.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A filter cartridge comprising:
a filter pack; and
a housing disposed about the filter pack, having an upper and a lower end thereof, and defining a sump extending substantially below the filter pack at the lower end of the housing;
the housing further comprising a drain fitting passing through the housing in the sump and attached to the housing;
the drain fitting having an outer periphery thereof including a crimping recess therein, and the housing having a crimped portion thereof formed into the crimping recess, to thereby form a crimped connection between the drain fitting and the housing.

2. The filter cartridge of claim 1, wherein the crimping recess includes at least one anti-rotation feature, around which the crimped portion of the housing is formed for resisting rotation of the drain fitting with respect to the housing.

3. The filter cartridge of claim 1, wherein the drain fitting defines an axis of passage through the housing, and the crimping recess is a radially outwardly opening groove.

4. The filter cartridge of claim 3, wherein the crimping recess includes at least one anti-rotation feature, around which the crimped portion of the housing is formed for resisting rotation of the drain fitting with respect to the housing.

5. The filter cartridge of claim 4, wherein the anti-rotation element comprises a raised rib extending outwardly from and extending substantially axially across the crimping recess.

6. The filter cartridge of claim 3, wherein the housing comprises a tubular wall section thereof, disposed about the periphery of the drain fitting and including the crimped portion of the housing.

7. The filter cartridge of claim 6, wherein the housing further comprises a cup-shaped extension including the tubular wall section, and having an axially facing end wall thereof joined to the tubular wall, the end wall having a hole therein providing fluid communication with the drain fitting.

8. The filter cartridge of claim 7, wherein:
the drain fitting is configured for operative attachment thereto of a drain cock; and
the end wall of the cup-shaped extension defines a sealing surface thereof, adapted for cooperatively forming a sealable juncture with the drain cock, to thereby selectively open or close-off fluid communication through the drain fitting.

9. A method for constructing a fluid filter cartridge, having a filter pack disposed within a filter housing having a drain fitting, the method comprising attaching the drain fitting to the housing with a crimped joint.

10. The method of claim 9, further comprising, installing the filter pack into the filter housing.

11. The method of claim 9, further comprising, providing at least one anti-rotation feature on the drain fitting for engagement by the housing as part of the crimped joint, to thereby resisting rotation of the drain fitting with respect to the housing.

12. The method of claim 11, further comprising, installing the filter pack into the filter housing.

13. The method of claim 9, further comprising:
configuring the housing to include a crimpable portion thereof for passage therethrough of the drain fitting; and
loosely inserting the drain fitting into the crimpable portion before forming the crimped joint.

14. The method of claim 13, further comprising:
configuring an outer peripheral surface of the drain fitting to include a crimping groove; and
forming the crimpable portion of the housing into the crimping groove of the drain fitting to thereby form a crimped joint between the housing and drain fitting.

15. The method of claim filter cartridge of claim 14, further comprising, configuring the housing to include a tubular wall section thereof, disposed about the periphery of the drain fitting and including the crimpable portion of the housing.

16. The method of claim 15, further comprising, configuring the housing to provide a cup-shaped extension thereof, with the cup-shaped extension including the tubular wall section, and having an axially facing end wall of the cup-shaped extension joined to the tubular wall, the end wall having a hole therein for providing fluid communication with the drain fitting.

17. The method of claim 16, further comprising, configuring the end wall of the cup-shaped extension to define a sealing surface thereof for cooperatively forming a sealable juncture with a sealing element, to thereby selectively open or close-off fluid communication through the drain fitting.

18. A filter cartridge apparatus, comprising:
a filter pack; and
a housing disposed about the filter pack, having an upper and a lower end thereof, and defining a sump extending substantially below the filter pack at the lower end of the housing;
the housing further comprising a drain fitting passing through the housing in the sump and attached to the housing, with the drain fitting defining an axis of passage through the housing;
the drain fitting having an outer periphery thereof including a crimping recess therein, in the form of a radially outwardly opening groove;
the crimping recess including at least one anti-rotation feature, in the form of a raised rib extending outwardly from and substantially axially across the crimping recess;
the housing having a crimped portion thereof formed into the crimping recess, to thereby form a crimped connection between the drain fitting and the housing;
the crimped portion of the housing being formed about the raised rib for resisting rotation of the drain fitting with respect to the housing.

19. The filter cartridge apparatus of claim 18, wherein:
the housing further comprises a cup-shaped extension including a tubular wall and an axially facing end wall thereof joined to the tubular wall;
the tubular wall section being disposed about the periphery of the drain fitting and including the crimped portion of the housing; and
the end wall of the cup-shaped extension having a hole therein providing fluid communication with the drain fitting.

20. The filter cartridge apparatus of claim 19, further comprising:
a sealing element for selectively opening or closing-off fluid communication through the drain fitting;
with the drain fitting being configured for operative attachment thereto of sealing element; and
the end wall of the cup-shaped extension defining a sealing surface thereof, adapted for cooperatively forming a sealable juncture with the sealing element.

21. The filter cartridge of claim 1, wherein, the housing is separable from the filter pack and reusable.

22. The filter cartridge of claim 1, wherein, the filter pack and housing are integrally joined to one another, and are replaceable only as a unit.

23. The filter cartridge of claim 22, wherein the filter cartridge is adapted for spin-on attachment to a filter base.

24. The method of claim 10, further comprising reusing the housing with a replacement filter pack.

25. The method of claim 10, further comprising, integrally joining the filter pack and housing to one another, to form a filter cartridge that is replaceable only as a unit.

26. The filter cartridge of claim 25, further comprising, constructing the filter cartridge for spin-on attachment to a filter base.

27. The filter cartridge apparatus of claim 18, wherein, the housing is separable from the filter pack and reusable.

28. The filter cartridge of claim 18, wherein, the filter pack and housing are integrally joined to one another, and are replaceable only as a unit.

29. The filter cartridge of claim 28, wherein the filter cartridge is adapted for spin-on attachment to a filter base.

30. A filter housing, for a filter cartridge having a filter pack, the housing comprising:
a housing wall, defining an inner cavity of the housing for receiving the filter pack therein, and having an upper and a lower end thereof, and also defining a sump extending substantially below the filter pack at the lower end of the housing, when the filter pack is installed in the housing;
the housing further comprising a drain fitting passing through the housing in the sump and attached to the housing;
the drain fitting having an outer periphery thereof including a crimping recess therein, and the housing having a crimped portion thereof formed into the crimping recess, to thereby form a crimped connection between the drain fitting and the housing.

31. The filter housing of claim 30, wherein, the housing is separable from the filter pack and reusable.

32. The filter housing of claim 30, wherein, the housing is adapted to have the filter pack permanently joined thereto, in such a manner that the housing and filter pack are replaceable only as a unit.

33. The filter cartridge of claim 32, wherein the filter cartridge is adapted for spin-on attachment to a filter base.

34. A method for constructing a filter housing, for a fluid filter cartridge having a filter pack disposed within a filter housing including a drain fitting, the method comprising attaching the drain fitting to the housing with a crimped joint.

35. The method of claim 34, further comprising constructing the housing to be reusable with a replacement filter pack.

36. The method of claim 34, further comprising, configuring the filter housing for integrally joining the filter pack and housing to one another, to form a filter cartridge that is replaceable only as a unit.

37. The method of claim 36, further comprising, constructing the filter housing and cartridge for spin-on attachment to a filter base.
